(19) United States
(12) Patent Application Publication
(10) Pub. No.: US 2021/0172319 A1
(43) Pub. Date: Jun. 10, 2021

(54) MULTILEVEL DEEP WELL COOLING AND GEOTHERMAL UTILIZATION SYSTEM AND PROCESS

(71) Applicant: CHINA UNIVERSITY OF MINING AND TECHNOLOGY, Xuzhou, Jiangsu (CN)

(72) Inventors: Jixiong ZHANG, Xuzhou, Jiangsu (CN); Meng LI, Xuzhou, Jiangsu (CN); A.J.S.(Sam) Spearing, Xuzhou, Jiangsu (CN); Baiyi LI, Xuzhou, Jiangsu (CN); Guohao MENG, Xuzhou, Jiangsu (CN); Hao YAN, Xuzhou, Jiangsu (CN)

(73) Assignee: CHINA UNIVERSITY OF MINING AND TECHNOLOGY, Xuzhou, Jiangsu (CN)

(21) Appl. No.: 16/763,788

(22) PCT Filed: Apr. 18, 2019
(86) PCT No.: PCT/CN2019/083211

§ 371 Date: May 13, 2020

(30) Foreign Application Priority Data
Oct. 15, 2018 (CN) 201811195212.4

(51) Int. Cl. E21F 3/00; E21B 36/00; F24T 10/20

(52) U.S. Cl. CPC E21F 3/00; F24T 10/20; E21B 36/001

(57) ABSTRACT

A multilevel deep well cooling and geothermal utilization system and process. The system has a deep well heat harnessing system, a shallow part heat-exchanging system, and a high-temperature water lifting system. The deep well heat harnessing system has a heat absorbing pipe, a thermally-conductive fluid lifting pipe, a thermally-conductive fluid lowering pipe, temperature sensors, and a water pump. The shallow part heat-exchanging system has a heat-dissipating pipe, a heat-storing water pool, a water intake pump, a water intake valve, a temperature sensor and a liquid level meter. The high-temperature water lifting system has a water discharging pump, a flowmeter, a water discharging valve, and a high-temperature water lifting pipe.

### I. TECHNICAL FIELD

The present invention belongs to the technical field of deep resource exploitation in coal mines, in particular to multi-level deep well cooling and geothermal utilization system and process.

### II. BACKGROUND ART

With the depletion of shallow coal mine resources in China, it is imperative to exploit deep coal mine resources. However, as the coal mining depth is increased, the ground temperature becomes higher and higher. In the case that the depth of the mine shaft exceeds 1,000 m, the ground temperature is usually higher than 50° C. The thermal damage problem incurred by high ground temperature has a strong impact on the physical and mental health of the coal miners, and restricts safe and efficient coal mine production.

At present, there are two ways to cool down the deep part of a mine shaft: one way is to establish a large-scale cooling system on the ground surface, convey cold water or ice blocks through a special pipeline to the underground portion, and then convey the same back to the ground surface for repeated cooling after heat exchange in the stope, so as to decrease the temperature in the stope. However, the method requires a huge system and high equipment investment, the depth of the mine shaft is great, it is difficult to carry out lifting and transportation, the operation cost is very high, and the heat exchange efficiency is low since water is used as the heat exchange medium, thus the requirements of a large-size mine shaft can't be met; the other way is to use local cooling means and achieve cooling by optimizing the stope layout and ventilation pattern and deploying local cooling facilities, etc., however, that method has low efficiency and poor cooling effect, and is only applicable to scenarios with a small stope scope.

### III. CONTENT OF THE INVENTION

Object of the Invention: in order to overcome the drawbacks in the prior art, the present invention provides multi-level deep well cooling and geothermal utilization system and process. The system is a system that utilizes multiple levels of the deep well for mine cooling and geothermal heat utilization, and has advantages including low equipment and operation cost, wide cooling range, excellent cooling effect, high geothermal heat utilization rate, low unit energy consumption, and high safety and reliability, etc.

Technical Solution: in order to attain the object described above, the present invention employs the following technical solution:

A multi-level deep well cooling and geothermal utilization system, including a deep well heat recovery system, a shallow heat exchange system, and a high-temperature water lifting system, which are sequentially arranged in a deep well from bottom to top;

The deep well heat recovery system is located at a deep level of the mine shaft and collects heat in the deep well, and includes a heat absorption pipeline, a heat-conducting fluid downward delivery pipeline connected to an inlet end of the heat absorption pipeline, and a heat-conducting fluid lifting pipeline connected to an outlet end of the heat absorption pipeline; a water pump is provided on the heat-conducting fluid lifting pipeline;

The shallow heat exchange system is located at a shallow level of the mine shaft, and utilizes the heat collected by the deep well heat recovery system to heat up water, and includes a heat storage pool and a heat dissipation pipeline arranged inside the heat storage pool to heat up the heat storage pool, the inlet end of the heat dissipation pipeline is connected with the heat-conducting fluid lifting pipeline, and the outlet end of the heat dissipation pipeline is connected with the heat-conducting fluid downward delivery pipeline; the heat storage pool is an enclosed space, and a water inflow pump and a water inflow valve are provided outside an water inlet end of the heat storage pool;

The top and bottom of the high-temperature water lifting system are connected to the ground surface and the shallow heat exchange system respectively, the high-temperature water lifting system is configured to lift the hot water heated in the shallow heat exchange system to the ground surface, and includes a water outflow valve and a high-temperature water lifting pipeline provided outside the heat storage pool, the water outflow valve is connected with a water outflow pump arranged outside the heat storage pool; the ground surface is connected with a hot water utilization system.

Further, the deep level of the mine shaft is at 2,000 m below the ground surface or deeper, and the shallow level of the mine shaft is at 800 to 1,000 m below the ground surface.

Further, the heat absorption pipeline is a closed pipeline, in which the heat-conducting fluid utilizes water as a distribution medium and utilizes phase-change material microparticles as a heat-absorbing material, wherein the phase-change material is determined according to the ground temperature condition at the deep level, the phase transition temperature is lower than the ground temperature at the deep level position by 5 to 10° C., the diameter of the phase-change material microparticles is centrally distributed within a range of 1 to 5 μm, and the concentration thereof in the heat-conducting fluid is 50 to 60%.

Further, a flow meter is arranged on the heat-conducting fluid downward delivery pipeline.

Further, temperature sensors are arranged on the heat absorption pipeline.

Further, a temperature sensor and a liquid level meter are provided in the heat storage pool.

Further, the water outflow valve is connected with a flow meter arranged inside the heat storage pool.

Further, the deep well heat recovery system is applied to a roadway cemented filling working face in the deep well, the heat absorption pipeline is composed of a linear section fixed at the center of the roof of a mining roadway, a reciprocating section arranged at the center of the roof of a connecting roadway at the roadway cemented filling working face, and a connecting section that is close to the coal wall and connects the pipeline in two working face connecting roadways; the spacing between the pipelines in the two working face connecting roadways depends on the cemented filling mining process, and usually is 20 to 40 m.

Further, the heat dissipation pipeline is arranged at the bottom of the heat storage pool, at 0.5 m from the bottom of the pool, and the pipeline is arranged in an “S” ring layout at 10 m spacing. The specific dimensions of the heat dissipation pipeline are related with the dimensions of the heat storage pool, and may be determined on the basis of the required amount of heat according to the actual circumstance.

The process flow of the multi-level deep well cooling and geothermal utilization system described above includes the following steps:
1) applying the deep well heat recovery system to the roadway cemented filling working face in the deep well, mounting the heat absorption pipeline at the center of the roof of the working face connecting roadway along with supporting work after mining in the connecting roadway of the roadway cemented filling working face in the deep well, and connecting the heat absorption pipeline between two adjacent working face connecting roadways after the mining in the working face connecting roadways is completed;
2) connecting the inlet end of the heat absorption pipeline (5) with the heat-conducting fluid downward delivery pipeline, connecting the outlet end of the heat absorption pipeline with the heat-conducting fluid lifting pipeline, and connecting the top end of the heat-conducting fluid downward delivery pipeline and the top end of the heat-conducting fluid lifting pipeline with the heat dissipation pipeline in the heat storage pool of the shallow heat exchange system to form a closed loop, according to the roadway cemented filling process, after the mining in a first circulation connecting roadway in the working face;
3) selecting a phase-change material with appropriate phase transition temperature according to the actual ground temperature condition at the deep level, preparing the phase-change material into heat-conducting fluid with certain concentration, adding the heat-conducting fluid into the entire pipeline, absorbing heat by means of the heat absorption pipeline at the deep level, utilizing the temperature sensors to monitor the temperature of the heat-conducting fluid in the pipeline, starting the water pump for circulation when the temperature rises to a preset value after a period of heat absorption, circulating the heated heat-conducting fluid in the heat absorption pipeline to the heat dissipation pipeline in the heat storage pool, and circulating the cooled heat-conducting fluid in the heat dissipation pipeline to the heat absorption pipeline;
4) monitoring the water temperature in the heat storage pool with the temperature sensor, starting the water outflow pump after the heat dissipation pipeline heats up the water in the heat storage pool to a certain temperature to lift the hot water via the high-temperature water lifting system to the ground surface for a hot water utilization system on the ground surface to utilize, monitoring the water level in the heat storage pool with the liquid level meter, starting the water inflow pump when the water level drops to a lower limit to supply cold water to the heat storage pool;
5) repeating the steps 3) to 4) to convert the geothermal energy into heat energy of water for long-term use through multiple levels of the deep mine shaft.

Benefits: compared with the prior art, the multi-level deep well cooling and geothermal utilization system and process provided in the present invention has the following advantages:
(1) Multiple levels of the mine shaft are utilized to convert the geothermal heat into the thermal energy of water, so as to reduce the equipment cost and difficulties in lifting and transportation, and facilitate the user on the ground surface;
(2) Constructing a heat exchange pool underground rather than on the ground surface can attain a better heat storage and insulation effect and reduce thermal loss;
(3) The heat-conducting fluid employs water as a distribution medium and employs phase-change material microparticles as a heat-absorbing material, compared with the case in which water or ice is solely used, the heat absorption capacity is higher, the efficiency is higher, and the geothermal heat in the deep well can be absorbed fully;
(4) A phase-change material is used in the underground water pool for heat dissipation, without mechanical cooling; thus, the cooling cost is reduced significantly;
(5) The heat absorption pipeline is mounted along with the mining at the roadway cemented filling working face, the pipeline layout is simple and the coverage is wide, the wearing of the pipeline is low, and the system can be used for a long term even after the mining at the working face is completed.

### IV. BRIEF DESCRIPTION OF DRAWINGS

FIG. 1 is a schematic diagram of the overall framework of the system in the present invention;

FIG. 2 is a schematic diagram of the overall structure of the system in the present invention;

FIG. 3 is a schematic diagram of the deep well heat recovery system in the present invention;

In the drawings: 1—deep well heat recovery system; 2—shallow heat exchange system; 3—high-temperature water lifting system; 4—ground surface; 5—heat absorption pipeline; 6-1—heat-conducting fluid downward delivery pipeline; 6-2—heat-conducting fluid lifting pipeline; 7-1—temperature sensor; 7-2—temperature sensor; 7-3—temperature sensor; 8-1—flow meter; 8-2—flow meter; 9—water pump; 10—heat storage pool; 11—heat dissipation pipeline; 12-1—water inflow pump; 12-2—water outflow pump; 13-1—water inflow valve; 13-2—water outflow valve; 14—liquid level meter; 15—high-temperature water lifting pipeline.

### V. EMBODIMENTS

The present invention discloses multi-level deep well cooling and geothermal utilization system and process. The system includes a deep well heat recovery system, a shallow heat exchange system and a high-temperature water lifting system. The deep well heat recovery system includes a heat absorption pipeline, a heat-conducting fluid lifting pipeline, a heat-conducting fluid downward delivery pipeline, a water pump, and a temperature sensor; the shallow heat exchange system includes a heat dissipation pipeline, a heat storage pool, a water inflow pump, a water inflow valve, a temperature sensor, and a liquid level meter; the high-temperature water lifting system includes a water outflow pump, a flow meter, a water outflow valve, and a high-temperature water lifting pipeline. The heat-conducting fluid utilizes water as a distribution medium and a phase change material as a heat-absorbing material; thus, the heat recovery efficiency and magnitude are significantly improved. The system provided in the present invention has a simple structure, can be used for a long term, utilizes a mine shaft for multi-level continuous cooling, and achieves a significant effect, a wide cooling range, a high geothermal utilization rate, and low unit energy consumption, thus effectively solves the problem of excessively high temperature at the coal working face in the deep well, and provides a comfortable working environment for the downhole workers.

Hereunder the present invention will be further detailed in embodiments, with reference to the accompanying drawings.

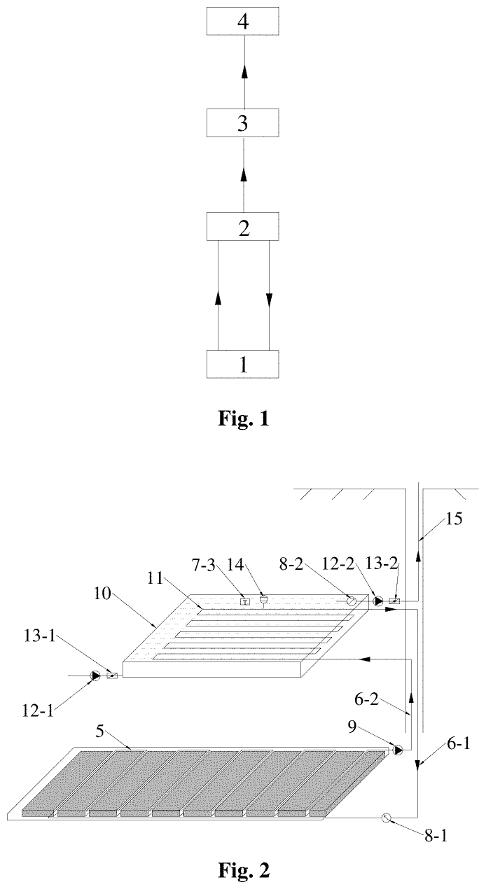

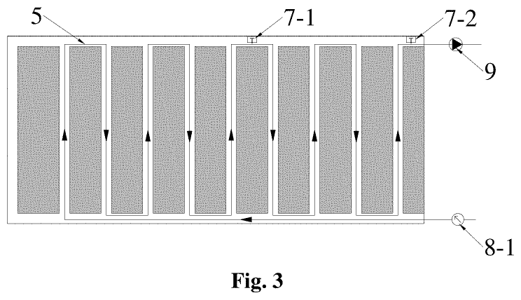

As shown in FIG. 1, a multi-level deep well cooling and geothermal utilization system includes a deep well heat recovery system 1, a shallow heat exchange system 2, and a high-temperature water lifting system 3;

The deep well heat recovery system 1 is located at a deep level of the mine shaft at 2,000 m or greater depth underground, and includes a heat absorption pipeline 5, a heat-conducting fluid downward delivery pipeline 6-1 connected to an inlet end of the heat absorption pipeline 5, and a heat-conducting fluid lifting pipeline 6-2 connected to an outlet end of the heat absorption pipeline 5; temperature sensors 7-1 and 7-2 are provided on the heat absorption pipeline, a flow meter 8-1 is provided on the heat-conducting fluid downward delivery pipeline 6-1, and a water pump 9 is provided on the heat-conducting fluid lifting pipeline;

the shallow heat exchange system 2 is located at a shallow level of the mine shaft at 800 to 1,000 m depth underground, and includes a heat storage pool 10 and a heat dissipation pipeline 11 for heating the heat storage pool 10, wherein the heat storage pool 10 is an enclosed space, a water inflow pump 12-1 and a water inflow valve 13-1 are provided at the water inlet end of the heat storage pool, and a temperature sensor 7-3 and a liquid level meter 14 are provided in the pool;

the high-temperature water lifting system 3 connects the shallow heat exchange system 2 and the ground surface 4, and includes a water outflow valve 13-2 and a high-temperature water lifting pipeline 15, wherein the water outflow valve 13-2 is connected with a flow meter 8-2 and a water outflow pump 12-2, and a hot water utilization system is connected on the ground surface 4.

The heat absorption pipeline 5 is a closed pipeline, in which the heat-conducting fluid utilizes water as a distribution medium and utilizes phase-change material microparticles as a heat-absorbing material, wherein the phase-change material is determined according to the ground temperature condition at the deep level, the phase transition temperature is lower than the ground temperature at the deep level by 5 to 10° C., the diameter of the phase-change material microparticles is centrally distributed within a range of 1 to 5 μm, and the concentration thereof in the heat-conducting fluid is 50 to 60%.

The deep well heat recovery system 1 is applied to a roadway cemented filling working face in the deep well, the heat absorption pipeline 5 is composed of a linear section fixed at the center of the roof of a mining roadway, a reciprocating section arranged at the center of the roof of a connecting roadway at the roadway cemented filling working face, and a connecting section that is close to the coal wall and connects the pipeline in two working face connecting roadways; the spacing between the pipelines in the two working face connecting roadways depends on the cemented filling mining process, and usually is 20 to 40 m.

The heat dissipation pipeline 11 is arranged at the bottom of the heat storage pool, at 0.5 m from the bottom of the pool, and the pipeline is arranged in an “S” ring layout at 10 m spacing.

The heat-conducting fluid downward delivery pipeline 6-1, the heat-conducting fluid lifting pipeline 6-2, and the high-temperature water lifting pipeline 15 are made of a heat insulating material, to reduce the heat loss of the fluid in the transportation process.

The process flow of the multi-level deep well cooling and geothermal utilization system in the present invention includes the following steps:
1) applying the deep well heat recovery system 1 to the roadway cemented filling working face in the deep well, mounting the heat absorption pipeline 5 at the center of the roof of the working face connecting roadway along with supporting work after mining in the connecting roadway of the roadway cemented filling working face in the deep well, and connecting the heat absorption pipeline between two adjacent working face connecting roadways after the mining in the working face connecting roadways is completed;
2) connecting the inlet end of the heat absorption pipeline (5) with the heat-conducting fluid downward delivery pipeline 6-1, connecting the outlet end of the heat absorption pipeline 5 with the heat-conducting fluid lifting pipeline 6-2, and connecting the top end of the heat-conducting fluid downward delivery pipeline 6-1 and the top end of the heat-conducting fluid lifting pipeline 6-2 with the heat dissipation pipeline 11 in the heat storage pool 10 of the shallow heat exchange system 2 to form a closed loop, according to the roadway cemented filling process, after the mining in a first circulation connecting roadway in the working face;
3) selecting a phase-change material with appropriate phase transition temperature according to the actual ground temperature condition at the deep level, preparing the phase-change material into heat-conducting fluid with certain concentration, adding the heat-conducting fluid into the entire pipeline, absorbing heat by means of the heat absorption pipeline 5 at the deep level, utilizing the temperature sensors 7-1 and 7-2 to monitor the temperature of the heat-conducting fluid in the pipeline, starting the water pump 9 for circulation when the temperature rises to a preset value after a period of heat absorption, circulating the heated heat-conducting fluid in the heat absorption pipeline 5 to the heat dissipation pipeline 11 in the heat storage pool 10, and circulating the cooled heat-conducting fluid in the heat dissipation pipeline 11 to the heat absorption pipeline 5;
4) monitoring the water temperature in the heat storage pool 10 with the temperature sensor 7-3, starting the water outflow pump 12-2 after the heat dissipation pipeline 11 heats up the water in the heat storage pool 10 to a certain temperature to lift the hot water via the high-temperature water lifting system 3 to the ground surface 4 for a hot water utilization system on the ground surface to utilize, monitoring the water level in the heat storage pool 10 with the liquid level meter 14, starting the water inflow pump 12-1 when the water level drops to a lower limit to supply cold water to the heat storage pool 10;
5) repeating the steps 3) to 4) to convert the geothermal energy into heat energy of water for long-term use through multiple levels of the deep mine shaft.

While the present invention is described above in some preferred embodiments, it should be noted that those skilled in the art can make various improvements and modifications without departing from the principle of the present invention, and those improvements and modifications should be deemed as falling in the protection scope of the present invention.

1. A multi-level deep well cooling and geothermal utilization system, comprising a deep well heat recovery system (1), a shallow heat exchange system (2), and a high-temperature water lifting system (3), which are sequentially arranged in a deep well from bottom to top;
wherein the deep well heat recovery system (1) is located at a deep level of the mine shaft and collects heat in the deep well, and comprises a heat absorption pipeline (5), a heat-conducting fluid downward delivery pipeline (6-1) connected to an inlet end of the heat absorption pipeline (5), and a heat-conducting fluid lifting pipeline (6-2) connected to an outlet end of the heat absorption pipeline (5); a water pump (9) is provided on the heat-conducting fluid lifting pipeline (6-2);
the shallow heat exchange system (2) is located at a shallow level of the mine shaft, utilizes the heat collected by the deep well heat recovery system (1) to heat up water, and comprises a heat storage pool (10) and a heat dissipation pipeline (11) arranged inside the heat storage pool (10) for heating the heat storage pool (10), an inlet end of the heat dissipation pipeline (11) is connected to the heat-conducting fluid lifting pipeline (6-2), and the outlet end of the heat dissipation pipeline (11) is connected to the heat-conducting fluid downward delivery pipeline (6-1); the heat storage pool (10) is an enclosed space, and a water inflow pump (12-1) and a water inflow valve (13-1) are provided outside an water inlet end of the heat storage pool (10);
the top and bottom of the high-temperature water lifting system (3) are connected to the ground surface (4) and the shallow heat exchange system (2) respectively, and the high-temperature water lifting system (3) is configured to lift the hot water heated in the shallow heat exchange system (2) to the ground surface (4), and comprises a water outflow valve (13-2) and a high-temperature water lifting pipeline (15) provided outside the heat storage pool (10), the water outflow valve (13-2) is connected with a water outflow pump (12-2) arranged outside the heat storage pool (10); the ground surface (4) is connected with a hot water utilization system.

2. The multi-level deep well cooling and geothermal utilization system according to claim 1, wherein the deep level of the mine shaft is at 2,000 m below the ground surface or deeper, and the shallow level of the mine shaft is at 800 to 1,000 m below the ground surface.

3. The multi-level deep well cooling and geothermal utilization system according to claim 1, wherein the heat absorption pipeline (5) is a closed pipeline, in which the heat-conducting fluid utilizes water as a distribution medium and utilizes phase-change material microparticles as a heat-absorbing material, wherein the phase-change material is determined according to the ground temperature condition at the deep level, the phase transition temperature is lower than the ground temperature at the deep level position by 5 to 10° C., the diameter of the phase-change material microparticles is centrally distributed within a range of 1 to 5 μm, and the concentration of the phase-change material microparticles in the heat-conducting fluid is 50 to 60%.

4. The multi-level deep well cooling and geothermal utilization system according to claim 1, wherein a flow meter (8-1) is provided on the heat-conducting fluid downward delivery pipeline (6-1).

5. The multi-level deep well cooling and geothermal utilization system according to claim 1, wherein temperature sensors (7-1, 7-2) are provided on the heat absorption pipeline (5).

6. The multi-level deep well cooling and geothermal utilization system according to claim 1, wherein a temperature sensor (7-3) and a liquid level meter (14) are provided in the heat storage pool (10).

7. The multi-level deep well cooling and geothermal utilization system according to claim 1, wherein the water outflow valve (13-2) is connected with a flow meter (8-2) arranged inside the heat storage pool (10).

8. The multi-level deep well cooling and geothermal utilization system according to claim 1, wherein the deep well heat recovery system (1) is applied to a roadway cemented filling working face in the deep well, the heat absorption pipeline (5) is composed of a linear section fixed at the center of the roof of a mining roadway, a reciprocating section arranged at the center of the roof of a connecting roadway at the roadway cemented filling working face, and a connecting section that is close to the coal wall and connects the pipeline in two working face connecting roadways; the spacing between the pipelines in the two working face connecting roadways is 20 to 40 m.

9. The multi-level deep well cooling and geothermal utilization system according to claim 1, wherein the heat dissipation pipeline (11) is arranged at the bottom of the heat storage pool, at 0.5 m from the bottom of the pool, and the pipeline is arranged in a “S” ring layout at 10 m spacing.

10. The multi-level deep well cooling and geothermal utilization system according to claim 1, wherein the process flow comprises the following steps:
1) applying the deep well heat recovery system (1) to the roadway cemented filling working face in the deep well, mounting the heat absorption pipeline (5) at the center of the roof of the working face connecting roadway along with supporting work after mining in the connecting roadway of the roadway cemented filling working face in the deep well, and connecting the heat absorption pipeline between two adjacent working face connecting roadways after the mining in the working face connecting roadways is completed;
2) connecting the inlet end of the heat absorption pipeline (5) with the heat-conducting fluid downward delivery pipeline (6-1), connecting the outlet end of the heat absorption pipeline (5) with the heat-conducting fluid lifting pipeline (6-2), and connecting the top end of the heat-conducting fluid downward delivery pipeline (6-1) and the top end of the heat-conducting fluid lifting pipeline (6-2) with the heat dissipation pipeline (11) in the heat storage pool (10) of the shallow heat exchange system (2) to form a closed loop, according to the roadway cemented filling process, after the mining in a first circulation connecting roadway in the working face;
3) selecting a phase-change material with corresponding phase transition temperature according to the actual ground temperature condition at the deep level, preparing the phase-change material into heat-conducting fluid with corresponding concentration, adding the heat-conducting fluid into the entire pipeline, absorbing heat by means of the heat absorption pipeline (5) at the deep level, utilizing the temperature sensors (7-1, 7-2) to monitor the temperature of the heat-conducting fluid in the pipeline, starting the water pump (9) for circulation when the temperature rises to a preset value after a period of heat absorption, circulating the heated heat-conducting fluid in the heat absorption pipeline (5) to the heat dissipation pipeline (11) in the heat storage pool (10), and circulating the cooled heat-conducting fluid in the heat dissipation pipeline (11) to the heat absorption pipeline (5);
4) monitoring the water temperature in the heat storage pool (10) with the temperature sensor (7-3), starting the water outflow pump (12-2) after the heat dissipation pipeline (11) heats up the water in the heat storage pool (10) to a preset temperature to lift the hot water via the high-temperature water lifting system (3) to the ground surface (4) for a hot water utilization system on the ground surface to utilize, monitoring the water level in the heat storage pool (10) with the liquid level meter (14), starting the water inflow pump (12-1) when the water level drops to a lower limit to supply cold water to the heat storage pool (10);
5) repeating the steps 3) to 4) to convert the geothermal energy into heat energy of water for long-term use through multiple levels of the deep mine shaft.
